(19) United States
(12) Patent Application Publication
(10) Pub. No.: US 2006/0290154 A1
(43) Pub. Date: Dec. 28, 2006

(54) One piece long glass fiber molded cross rail with integrated end stanchions

(75) Inventor: Craig A. Stapleton, St. Clair, MI (US)

Correspondence Address: Warn, Hoffmann, Miller & LaLone, P.C., P.O. Box 70098, Rochester Hills, MI, 48307, US

(73) Assignee: Magna International Inc., Aurora (CA)

(21) Appl. No.: 11/166,468

(22) Filed: Jun. 24, 2005

(51) Int. Cl. B60R 9/00; B60P 3/00

(52) U.S. Cl. 296/3; 224/326

(57) ABSTRACT

A cross rail system for a cargo rack system of a vehicle is provided. The system includes a cross rail member, wherein the cross rail member can include short and/or long glass fibers and a mesh material contained therein. A noise abatement system can be disposed on a surface of the cross rail member. A stanchion portion is integrally formed on at least one end of the cross rail member. A fastening system, such as cooperating fastening members and lock plates and/or clamp jaws, are operable to fasten the stanchion portion to a side rail member of the cargo rack system.

### FIELD OF THE INVENTION

The present invention generally relates to a cargo rack for motor vehicles and more specifically to cargo rack systems for a motor vehicle including cross rail members having stanchion portions incorporated therein.

### BACKGROUND OF THE INVENTION

Cargo racks for motor vehicles are generally well known in the art. Many vehicles have cargo racks comprising frames and/or rails on their exterior surfaces, such as their roof, on which luggage or other cargo can be placed for transport. Typically, such cargo racks include strips or rails on which the cargo is placed to prevent the cargo from directly contacting the vehicle surface to prevent damage thereto and/or to spread the load of the cargo over a larger area of the vehicle surface to prevent deformation of vehicle body panels. Further, cargo racks typically provide some mechanism, such as surrounding rails, tie downs and/or enclosures to prevent undesired movement of the cargo on the surface and to keep the cargo on the cargo rack while the vehicle moves.

Current conventional cargo rack adjustable cross rail construction typically involves multiple components, e.g., metal cross rails and end stanchion subassemblies that are fastened to each end of the metal cross rail. This type of multi-piece construction lends itself to reduced structure and tolerance stack up problems. To achieve the proper structure, steel rails are used which are generally very heavy. Aluminum rails can be substituted but at a cost penalty.

Additionally, current factory-installed metal cross rails have experienced significant wind noise problems. To try and eliminate the wind noise problems, costly add-on caps, rub strips and texture painting have been employed.

Therefore, there exists a need for new and improved cargo rack systems, especially new and improved cross rail members that have, among other features, sufficient strength characteristics, are not comprised of excessively heavy materials, are easy and inexpensive to manufacture, and eliminate, reduce or at least abate any wind noise problems.

### SUMMARY OF THE INVENTION

It is an object of the present invention to provide a new and improved cargo rack system for motor vehicles which obviates at least one disadvantage of the prior art.

It is an object of the present invention to provide a one piece, low cost, structural cross rail member with end stanchions incorporated therein with a simple and inexpensive latching system.

The cross rail members of the present invention are easy to manipulate and position by the owner, e.g., the cross rail members can be easily installed, removed and reinstalled if desired. The cross rail members of the present invention are adjustable for varying length loads.

The cross rail system of the present invention locks positively into location to avoid any load shifting along the rack side rails during use. Additionally, the cross rail members of the present invention are constructed of relatively light weight materials in comparison to current cross rail systems. Furthermore, wind noise abatement features are incorporated (e.g., by molded techniques) into the cross rail members of the present invention. Also, no secondary finishes are required and the entire system can be molded in various different colors. Further, overall assembly tolerance is less than the current construction tolerance stack up.

In accordance with a first embodiment of the present invention, a cross rail system for a cargo rack system of a vehicle is provided, comprising: (1) a cross rail member; (2) a stanchion portion integrally formed on at least one end of the cross rail member; and (3) a fastening system operable to fasten the stanchion portion to a side rail member of the cargo rack system.

In accordance with a second embodiment of the present invention, a cross rail system for a cargo rack system of a vehicle is provided, comprising: (1) a cross rail member, wherein the cross rail member is comprised of a material selected from the group consisting of short glass fibers, long glass fibers, and combinations thereof, wherein the cross rail member includes a mesh material contained therein; (2) a stanchion portion integrally formed on at least one end of the cross rail member; and (3) a fastening system operable to fasten the stanchion portion to a side rail member of the cargo rack system.

In accordance with a third embodiment of the present invention, a cross rail system for a cargo rack system of a vehicle is provided, comprising: (1) a cross rail member, wherein the cross rail member is comprised of a material selected from the group consisting of short glass fibers, long glass fibers, and combinations thereof, wherein the cross rail member includes a mesh material contained therein, wherein the cross rail member includes a noise abatement system disposed on a surface thereof; (2) a stanchion portion integrally formed on at least one end of the cross rail member; and (3) a fastening system operable to fasten the stanchion portion to a side rail member of the cargo rack system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded view of a cross rail system, in accordance with a first embodiment of the present invention;

FIG. 2 is a sectional view taken along line 2-2 of FIG. 1, in accordance with a first embodiment of the present invention;

FIG. 3 is an exploded view of an alternative cross rail system, in accordance with a second embodiment of the present invention; and

FIG. 4 is a sectional view taken along line 44 of FIG. 3, in accordance with a second embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention eliminates the need for separate metal cross rail members and end stanchion subassemblies. The cross rail members and end stanchion portions are formed into a one-piece integral member. Only the end stanchion mechanism components (e.g., screws, locking plates, skid pads and/or the like) are separate parts that make up the final assembly. Therefore, there are no weak joints between the cross rail member and the end stanchion portions, no fasteners are required to attach the stanchions to the cross rail member, and assembly labor is reduced.

In accordance with one aspect of the present invention, the cross rail members of the present invention are comprised, at least in part, of long glass fibers. By “long glass fibers,” as that phrase is used herein, it is meant any type of glass fiber that has a length of 0.5 inches or longer (e.g., up to about 2 inches). It should be appreciated that short glass fibers can also be used in the practice of the present invention, as well, e.g., in conjunction with the long glass fibers or in lieu of the long glass fibers. By “short glass fibers,” as that phrase is used herein, it is meant any type of glass fibers that has a length less than 0.5 inches, e.g., typically around 0.125 inches.

In accordance with one aspect of the present invention, these glass fibers, whether long and/or short, can be incorporated into a preferably moldable material, such as but not limited to plastic materials, such as but not limited to thermosets, thermoplastics, and/or the like. By way of a non-limiting example, long glass fibers having a length of 0.5 inches are combined with polypropylene to form pellets suitable for subsequent molding operations to form the cross rail members of the present invention.

Additionally, the cross rail members of the present invention include a metallic support material, such as but not limited to a wire mesh insert, formed therewith. The structure of the long glass fiber is very high, but it is supplemented by the addition of an insert molded wire mesh into the cross rail member. This mesh is intended to add additional structure and significantly reduces the thermal expansion and contraction of the assembly. The mesh also is intended to tighten the overall tolerance of the assembly over conventional construction. This construction also is intended to reduce the total weight of the assembly over conventional construction.

The molding process of the cross rail member allows for the addition of all of the wind noise abatement features to be added into the molding tool. This eliminates all of the costly add on caps and rub strips and reduces assembly labor.

The plastic material comprising the cross rail members of the present invention is UV stable, and therefore can be produced as molded in color, i.e., no need for secondary finishing is required, as is the case with conventional metal rails. The fewer number of components (e.g., separate end stanchions, fasteners to install end stanchions, wind noise abatement add on features and/or the like) reduce the overall cost to produce the assembly both in piece price and tooling.

The cross rail member of the present invention is an aerodynamic and structural load bearing section. The section incorporates all of the known best practices in the industry to eliminate potential wind noise (e.g., texture grain, trip beads, sine wave bead, splayed tread, elliptical contours and/or the like) molded in. Each end of the cross rail members has the end stanchion portions integrated therein in the molding process.

The undersurface of the cross rail member can have wire mesh material insert molded to achieve the required strength and rigidity. This wire mesh also controls any twist or warping that may be induced by the manufacturing process. The wire mesh can significantly reduce the overall thermal expansion and contraction. The wire mesh can be comprised of any number of materials, such as but not limited to metallic materials, such as but not limited to steel, copper and/or the like. By way of a non-limiting example, the wire mesh material can be comprised of steel, such as but not limited to a 0.25 inch square steel wire mesh including wire having a 0.032 inch diameter. However, it should be appreciated that wire mesh materials having different configurations and/or wire diameters can be used in the practice of the present invention. In accordance with a preferred embodiment of the present invention, the wire mesh materials can be configured in a square shape from about 0.0625 inches to about 0.625 inches long. In accordance with a more preferred embodiment of the present invention, the wire mesh materials can be configured in a square shape from about 0.09375 inches to about 0.50 inches long. In accordance with a still more preferred embodiment of the present invention, the wire mesh materials can be configured in a square shape from about 0.125 inches to about 0.375 inches long. In accordance with a preferred embodiment of the present invention, the wire mesh materials can have a wire diameter thickness in the range of about 0.015625 inches to about 0.125 inches. In accordance with a more preferred embodiment of the present invention, the wire mesh materials can have a wire diameter thickness in the range of about 0.023438 inches to about 0.09375 inches. In accordance with a still more preferred embodiment of the present invention, the wire mesh materials can have a wire diameter thickness in the range of about 0.03125 inches to about 0.0625 inches.

The integrated end stanchions can have optional integrated tie loop holes to secure cargo with rope, cords, lines and/or the like. These tie loops can be configured in any number of desired shapes.

In accordance with one aspect of the present invention, the cross rail system of the present invention can be designed to be either a removable or permanently (or at least substantially permanently) attached adjustable system that can slide and lock into location along the length of the cargo rack side rail member.

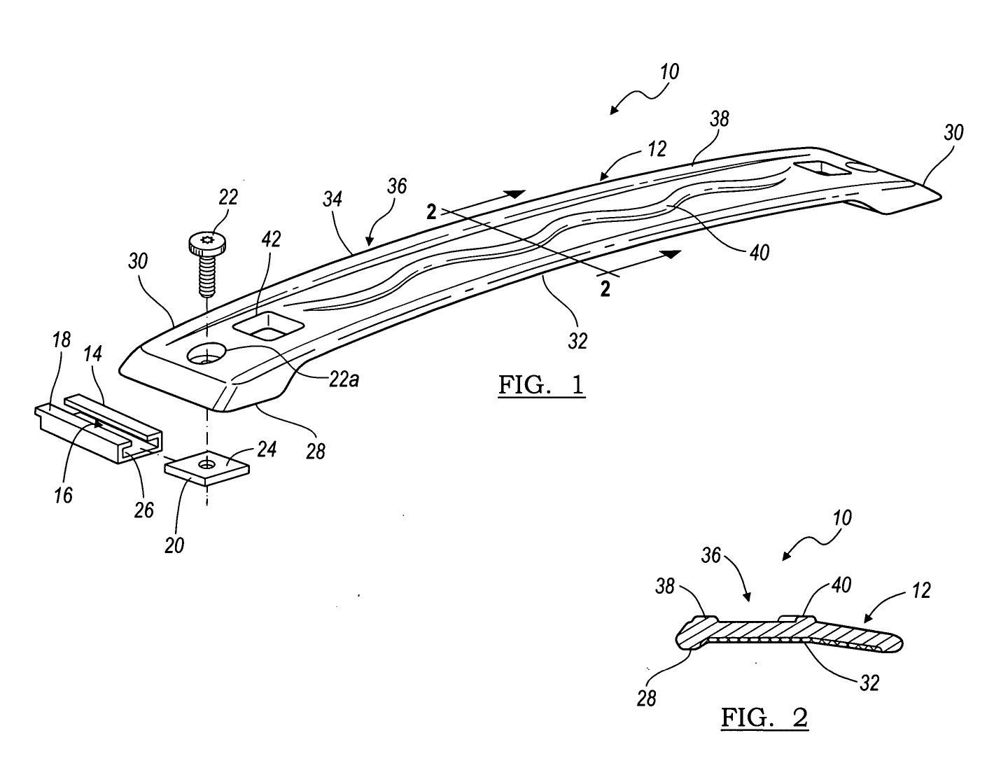

With respect to the permanently attached systems, as shown in FIGS. 1 and 2, the cross rail system 10 includes a cross rail member 12 that is operable to attach to the side rail member 14 through a “T” slot 16 in the top surface 18 of the side rail member 14. The clamping into location along the length of the side rail member 14 is accomplished with a threaded lock plate 20 and a threaded fastener or thumbwheel 22. By way of a non-limiting example, the top surface 24 of the lock plate 20 has a spline knurl that interlocks with a spline knurl on the undersurface 26 of the “T” slot 16 in the side rail member 14. The lock plate 20 achieves this by clamping the “T” slot 16 of the side rail member 14 between the top of the lock plate 20 and the bottom surface 28 of the cross rail member's integrated end stanchion portion 30 (it should be appreciated that each end of the cross rail member 12 would be provided with an integral end stanchion portion). The threaded fastener or thumbwheel 22 (which is operable to be received within an aperture 22a formed in the end stanchion portion 30) provides the clamping force to pull the lock plate 20 up and interlock the knurls of the lock plate 20 and the “T” slot 16. The end of the threaded fastener 22 is preferably disrupted after assembly to prevent the assembly from being easily dissembled.

The bottom surface 28 of the cross rail member 12 can be provided with a reinforcement material, such as but not limited to a wire mesh 32, the function of which has been described herein. Additionally, the top surface 34 of the cross rail member 12 can be provided with noise abatement devices 36 such as but not limited to aero trip beads 38, sine wave wind noise abatement members 40, and/or the like. Furthermore, areas defining tie loops 42 can also be provided on the cross rail member 12.

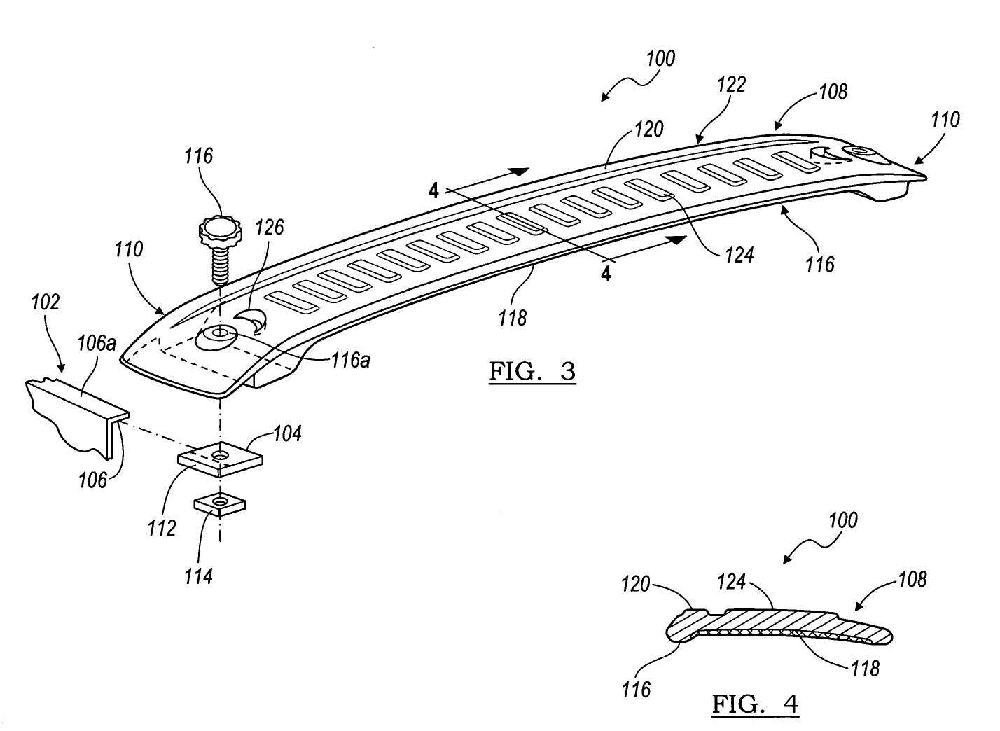

The removable system 100, as shown in FIGS. 3 and 4, is similar to the permanently attached system depicted in FIGS. 1 and 2. The difference is that, instead of a threaded lock plate that rides in a “T” slot of the side rail member 102, this system 100 uses a molded or stamped clamp jaw 104 that pulls up tight to the bottom surface 106 of the side rail member 102, in proximity to a flange member 106a. Securing the cross rail member 108, specifically the integral end stanchion portion 110 into location is achieved by anti-slip compression pads 112 that are attached to the clamp jaw 104 (it should be appreciated that each end of the cross rail member 108 would be provided with an integral end stanchion portion). When the cross rail member 108 is clamped into location, the anti-slip pads 112 resist fore/aft movement of the cross rail member 108 along the side rail member 102. The molded clamp jaw 104 has an insert-molded or post-installed threaded nut 114 in the bottom surface of the clamp jaw 104 for the threaded fastener or thumbwheel 116 to engage (which is operable to be received within an aperture 116a formed in the end stanchion portion 110). By way of a non-limiting example, the stamped metal clamp jaw 104 can have a weld nut, a rivnut, or a clinch nut installed on the bottom surface thereof.

The bottom surface 116 of the cross rail member 108 can be provided with a reinforcement material, such as but not limited to a wire mesh 118, the function of which has been described herein. Additionally, the top surface 120 of the cross rail member 108 can be provided with noise abatement devices 122 such as but not limited to splayed wind noise abatement treads 124 and/or the like. Furthermore, areas defining tie loops 126 can also be provided on the cross rail member 108.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cross rail system for a cargo rack system of a vehicle, comprising:
a cross rail member;
a stanchion portion integrally formed on at least one end of the cross rail member; and
a fastening system operable to fasten the stanchion portion to a side rail member of the cargo rack system.

2. The invention according to claim 1, wherein the side rail member includes an area defining a channel formed therein, wherein the fastening system is operable to be at least partially received in the channel.

3. The invention according to claim 2, wherein the fastening system comprises:
a fastening member, wherein the fastening member is operable to be received within an area defining an aperture formed in the stanchion portion; and
a plate member, wherein the plate member is operable to be at least partially received in the channel;
wherein the stanchion portion is operable to be fastened to the side rail member wherein the plate member is received in the channel and the fastening member is received in the aperture such that the fastening member is operable to be engaged to the plate member.

4. The invention according to claim 1, wherein the cross rail member is comprised of a material selected from the group consisting of short glass fibers, long glass fibers, and combinations thereof.

5. The invention according to claim 1, wherein the cross rail member optionally includes a mesh material contained therein and a noise abatement system disposed on a surface thereof.

6. The invention according to claim 5, wherein the mesh material is configured in a square shape from about 0.0625 inches to about 0.625 inches long.

7. The invention according to claim 5, wherein the mesh material includes a wire diameter thickness in the range of about 0.015625 inches to about 0.125 inches.

8. The invention according to claim 1, wherein the side rail member includes a flange member extending from a surface thereof, wherein the fastening system is operable to engage at least a portion of the flange member.

9. The invention according to claim 8, wherein the fastening system comprises:
a fastening member, wherein the fastening member is operable to be received within an area defining an aperture formed in the stanchion portion; and
a clamp jaw member, wherein the clamp jaw member is operable to engage at least a portion of the flange member;
wherein the stanchion portion is operable to be fastened to the side rail member wherein the clamp jaw is engaged against the flange member and the fastening member is received in the aperture such that the fastening member is operable to be engaged to the clamp jaw member.

10. A cross rail system for a cargo rack system of a vehicle, comprising:
a cross rail member, wherein the cross rail member is comprised of a material selected from the group consisting of short glass fibers, long glass fibers, and combinations thereof, wherein the cross rail member includes a mesh material contained therein;
a stanchion portion integrally formed on at least one end of the cross rail member; and
a fastening system operable to fasten the stanchion portion to a side rail member of the cargo rack system.

11. The invention according to claim 10, wherein the side rail member includes an area defining a channel formed therein, wherein the fastening system is operable to be at least partially received in the channel.

12. The invention according to claim 11, wherein the fastening system comprises:
a fastening member; and
a plate member;
wherein the fastening member is operable to be received within an area defining an aperture formed in the stanchion portion;
wherein the plate member is operable to be at least partially received in the channel;
wherein the stanchion portion is operable to be fastened to the side rail member wherein the plate member is received in the channel and the fastening member is received in the aperture such that the fastening member is operable to be engaged to the plate member.

13. The invention according to claim 10, wherein the cross rail member includes a noise abatement system disposed on a surface thereof.

14. The invention according to claim 10, wherein the side rail member includes a flange member extending from a surface thereof, wherein the fastening system is operable to engage at least a portion of the flange member.

15. The invention according to claim 14, wherein the fastening system comprises:
a fastening member; and
a clamp jaw member;
wherein the fastening member is operable to be received within an area defining an aperture formed in the stanchion portion;
wherein the clamp jaw member is operable to engage at least a portion of the flange member;
wherein the stanchion portion is operable to be fastened to the side rail member wherein the clamp jaw is engaged against the flange member and the fastening member is received in the aperture such that the fastening member is operable to be engaged to the clamp jaw member.

16. A cross rail system for a cargo rack system of a vehicle, comprising:
a cross rail member, wherein the cross rail member is comprised of a material selected from the group consisting of short glass fibers, long glass fibers, and combinations thereof, wherein the cross rail member includes a mesh material contained therein, wherein the cross rail member includes a noise abatement system disposed on a surface thereof;
a stanchion portion integrally formed on at least one end of the cross rail member; and
a fastening system operable to fasten the stanchion portion to a side rail member of the cargo rack system.

17. The invention according to claim 16, wherein the side rail member includes an area defining a channel formed therein, wherein the fastening system is operable to be at least partially received in the channel.

18. The invention according to claim 17, wherein the fastening system comprises:
a fastening member; and
a plate member;
wherein the fastening member is operable to be received within an area defining an aperture formed in the stanchion portion;
wherein the plate member is operable to be at least partially received in the channel;
wherein the stanchion portion is operable to be fastened to the side rail member wherein the plate member is received in the channel and the fastening member is received in the aperture such that the fastening member is operable to be engaged to the plate member.

19. The invention according to claim 16, wherein the side rail member includes a flange member extending from a surface thereof, wherein the fastening system is operable to engage at least a portion of the flange member.

20. The invention according to claim 19, wherein the fastening system comprises:
a fastening member; and
a clamp jaw member;
wherein the fastening member is operable to be received within an area defining an aperture formed in the stanchion portion;
wherein the clamp jaw member is operable to engage at least a portion of the flange member;
wherein the stanchion portion is operable to be fastened to the side rail member wherein the clamp jaw is engaged against the flange member and the fastening member is received in the aperture such that the fastening member is operable to be engaged to the clamp jaw member.
